(19) United States
(12) Patent Application Publication
(10) Pub. No.: US 2015/0079943 A1
(43) Pub. Date: Mar. 19, 2015

(54) RESTRICTING FUNCTIONALITY OF PROTECTED DEVICES

(71) Applicant: Aegis Mobility, Inc., Burnaby (CA)

(72) Inventor: Stephen J. Williams, Vancouver (CA)

(21) Appl. No.: 14/490,590

(22) Filed: Sep. 18, 2014

Related U.S. Application Data
(60) Provisional application No. 61/978,133, filed on Apr. 10, 2014.
(60) Provisional application No. 61/904,112, filed on Nov. 14, 2013.
(60) Provisional application No. 61/880,114, filed on Sep. 19, 2013.

(51) Int. Cl. H04W 12/08

(52) U.S. Cl. CPC H04W 12/08
USPC 455/411

(57) ABSTRACT

Systems, methods and interfaces are disclosed for restricting functionality of protected mobile communication devices. Protected mobile communication devices may generally include mobile communication devices that do not allow applications to directly restrict the mobile communication device's functionalities, such as call reception or access to a standard user interface. Specifically, a mobile application can monitor the context of the mobile communication device to determine whether the device is in one of three states: inactive; active and locked; or active and under the application's control. When the device enters the active and locked state, the mobile application can ensure that unlocking the device places the device under the application's control. Further, when the device is under the application's control, the mobile application can ensure that leaving the application's control places the device in a locked state. The device can therefore be restricted to functionality provided under these three states.

### CROSS-REFERENCE TO RELATED APPLICATIONS

This application claims the benefit of U.S. Provisional Patent Application No. 61/978,133, entitled RESTRICTING FUNCTIONALITY OF PROTECTED DEVICES, and filed Apr. 10, 2014; U.S. Provisional Patent Application No. 61/904,112, entitled RESTRICTING FUNCTIONALITY OF PROTECTED DEVICES, and filed Nov. 14, 2013; and U.S. Provisional Patent Application No. 61/880,114, entitled ENFORCING DEVICE POLICY RESTRICTIONS, and filed Sep. 19, 2013, the entireties of which are incorporated herein by reference.

### BACKGROUND

Mobile communication devices, such as mobile phones, can facilitate communications on behalf of users. However, a number of risks are associated with use of mobile communication devices, especially when used in high risk or hazardous conditions. By way of example, driver distraction can be responsible for a large and growing number of road traffic accidents. One increasing cause of driver distraction is the operation of a mobile communication device while driving, such as for the purposes of audio conversation. As applied to driving (and other activities), the distraction associated with operation of a mobile communication device can be characterized in terms of the mechanical operation of the device (e.g., dialing numbers on a keypad to initiate a call) or the cognitive load of the subsequent communication session (voice communications or operation of the device). Additionally, the continued evolution of mobile communication devices into multifunctional components, such as for text messaging, image and video capture, handheld gaming, etc., continues to increase the potential for operator distraction or additional cognitive load on users during operation of the mobile communication device.

In order to reduce or eliminate risk, a mobile communication device can utilize an application that limits device functionality during high risk situations. For example, a mobile application may monitor a state of a mobile communication device (e.g., via GPS, accelerometer, etc.), and restrict the device's functionality under predetermined conditions. Restriction in functionality may include limiting the ability of the user to access the mobile communication device's interface, to access other applications, or to make or receive phone calls or messages. Accordingly, a user may be unable to engage in these activities under high risk conditions.

However, not all mobile communication devices allow an application to restrict functionality as described above. In some instances, one or more functionalities of the mobile communication device are protected from control or interference by mobile applications. For example, an operating environment on the mobile communication device may not enable an application to directly control incoming phone calls or notifications (e.g., related to an incoming message). As a further example, a mobile communication device may not enable an application to prevent a user from accessing the mobile communication device's interface (e.g., the device's “launcher”). Accordingly, traditional applications are unable to restrict the functionality of these protected mobile communication devices.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of one embodiment of a protected mobile communication device, including a control application that restricts functionality of the protected mobile communication device under a defined set of conditions;

FIG. 2 is a state diagram depicting an illustrative routine for restricting functionality of a protected device;

FIGS. 3 and 4 are illustrative user interfaces depicting the use of a protected mobile communication device under hazardous conditions; and

FIG. 5 is an illustrative routine for restricting functionality of a mobile communication device by use of an external disabling device.

### DETAILED DESCRIPTION

Generally described, embodiments of the present relate to restricting functionality of protected mobile communication devices (e.g., under hazardous or other predetermined conditions). Protected mobile communication devices, as used herein, may generally refer mobile communication devices that do not allow mobile applications to receive notice of or directly control some operation or functionality of the mobile communication device (e.g., incoming phone calls or notifications, access to standard user interfaces or other applications, etc.). Specifically, the systems and methods disclosed herein may utilize a control application provisioned on a protected mobile communication device. The control application is configured to ensure that the state of the protected mobile communication device is restricted to one of a number of known states, including an inactive state, an active and disabled state (e.g., by use of a locking functionality), or an active state executing an allowed application or functionality. The functionality of the protected mobile communication device can therefore be limited to the functionality provided by the control application.

Protections on mobile communication devices may be implemented due to a number of concerns. For example, an operating environment (e.g., an operating system) on a mobile communication device may be designed or configured to emphasize control by the user, thereby enabling the user to override attempted actions of applications, including a control application. Further, limiting the potential functionalities of an application may reduce the complexity of a device or operating system's design. Accordingly, developing applications for protected mobile communication devices may pose a number of difficulties for developers. For example, protected mobile communication devices (or other operating system of such devices) may limit the amount of information available to applications other than a currently executing primary application. Illustratively, “background applications” (e.g., applications other than the primarily executing application visible to the user) may not be notified of specific events, such as reception of an incoming call or text message. Further, background applications may not generally be enabled by a protected mobile communication device (or other operating system of such a device) to spontaneously modify their background processing state (e.g., by leaving the background to become a primarily executing application). Still further, background applications may not be provided with the ability to directly modify functionality of a protected mobile communication device (e.g., call processing or reception functionality). For example, a protected mobile communication device (or the operating system of such a device) may prevent a background application from directly interacting with a call stack associated with radio functionality of the protected mobile communication device. Examples of protected mobile communication devices include devices running APPLE IOS™ operating systems (initially released on Jun. 29, 2007), such as the APPLE IPHONE™ and APPLE IPAD™. Currently, a substantial portion of the mobile communication device market is occupied by protected mobile communication devices. While illustrative examples will be provided herein with reference to devices running APPLE IOS™ operating systems, embodiments of the present application may also be utilized by devices utilizing other operating systems, such as the GOOGLE ANDROID™ operating systems (or variants and derivations thereof) and the MICROSOFT WINDOWS PHONE™ operating systems.

A user or administrator of a protected mobile communication device may desire to restrict functionality of the device for a number of reasons. For example, a company may desire to limit the functionality of employees' protected mobile communication devices while the employees are driving. As a further example, parents may wish to limit the functionalities of children's protected mobile communication devices while in certain locations, such as schools. However, when a user possesses a protected mobile communication device, it may be difficult or impossible for companies, parents, administrators or other users to enforce restrictions on the protected mobile communication device. Accordingly, an adequate solution for limiting functionality of a protected mobile communication device would address a long felt and unsolved need among these companies, parents, administrators and other users.

While previous systems and methods to restrict functionality of protected mobile communication devices have been proposed or attempted, these solutions have generally been inadequate. For example, one previous solution attempts to restrict functionality of protected mobile communication devices by continuously causing the device to display notifications to the user. These notifications generally interrupt any current activity of the user, and present the user with an option to open a specified application (such as a predetermined distracted driving application). However, many protected mobile communication devices, such as those based on the APPLE IOS™ operating system, also enable a user to cancel a notification, returning the user to their previous location within the mobile communication device (and enabling unrestricted use of the device). Further, a protected mobile communication device may not enable an application to determine whether a user has ignored a notification (and therefore, that functionality of the device is still restricted by virtue of the notification), or whether the user has canceled the notification. In an attempt to circumvent these restrictions and ensure that a user was unable to gain unrestricted use of the device by canceling the notification, previous solutions cause the device to continuously display new notifications. Accordingly, in those previous solutions, user cancelation of a notification causes a new notification to immediately or substantially immediately be displayed, inhibiting use of the device.

However, a solution requiring continuous display of notifications on a device is associated with significant drawbacks. For example, continuous notifications may significantly increase use of the mobile communication device's processor and display, thereby increasing battery consumption and significantly decreasing batter life. As battery life is often a top desire of mobile communication device users, continuous notification solutions are unlikely to be widely adopted.

In addition, previous systems and methods have been attempted which attempt to ensure compliance with a set of restrictions, without enforcing those restrictions on a mobile communication device. For example, such systems (which may include, for example, software executing on a mobile communication device) may monitor the use of a mobile communication device in an attempt to detect undesired or unauthorized use (e.g., use while driving a vehicle), and transmit notifications to a monitoring entity when such use is detected. However, the inability of such systems to enforce restrictions leads to substantial disadvantages. Illustratively, where undesired behavior can potentially lead to immediate harm, such as a crash, monitoring systems may be insufficient in preventing such harm.

The systems and methods disclosed in the present application enable restriction of functionality of protected mobile communication devices while minimizing or overcoming the disadvantages present within previous solutions. Specifically, as noted above, embodiments disclosed herein can utilize a control application to ensure that a protected mobile communication device is placed in one of a number of known states, including an inactive state, an active and disabled (e.g., locked) state, and an active (e.g., unlocked) state executing an allowed application or functionality.

As described herein, an inactive state (e.g., an idle state) may generally correspond to a state in which the user is not interacting substantially with functionality of the device. For example, a protected mobile communication device may be considered in an inactive state when the display of the device is disabled by the user, disabled due to inactivity, or otherwise off. Generally, there may be little or no need to disable functionality of the protected mobile communication device when the device is in an inactive state.

An active and disabled state may generally correspond to a state in which the functionality of a protected mobile communication device is limited either inherently (e.g., by hardware configuration or by the operating system of the mobile communication device) or by modification of the mobile communication device. For example, an active and disabled state may be associated with a “lock screen” in which the operating environment prohibits accessing or initiating functionality of the mobile communication device prior to an unlocking mechanism. Lock screens may function, for example, to inhibit unintended use of the mobile communication device (e.g., “pocket dialing”) or to increase security of the mobile communication device (e.g., by requiring authentication to unlock).

As a further example, an active and disabled state may be associated with modification of the functionality of the device by disabling either or both of a set of inputs or a set of outputs of the mobile communication device. For example, an active and disabled state may include dimming or blanking the screen of the mobile communication device to a degree that a user is unable to effectively interact with the device. As a further example, an active and disabled state may include disabling an input of the device (e.g., a touchscreen of a mobile phone), thereby preventing a user from interacting with the device. Accordingly, there may be a reduced need for a control application to limit functionality of a protected mobile communication device when the device is locked.

In one embodiment, the control application may ensure that, when the device is active and disabled, any attempt to re-enable the device (e.g., by unlocking of the device) places the device in the control application's supervision and control. For example, assume that a protected mobile communication device, on re-enablement or unlocking, is configured to display an application associated with the most recent notification displayed by the protected mobile communication device. Accordingly, the control application can be configured to ensure that the most recent notification displayed by the protected mobile communication device is always associated with the control application. In this manner, when the protected mobile communication device is re-enabled or unlocked, the device will be placed under the control application's control.

Further, the control application can be configured to ensure that a user of the protected mobile communication device cannot leave the control application, or cannot launch an unapproved application. Specifically, the control application can be configured to detect the launch of an unapproved application or exiting of the control application, and in response, to move the protected mobile communication device into an active and disabled state (e.g., via locking the mobile communication device). Because any attempt to unlock or otherwise re-enable the mobile communication device will return the device to the control application's supervision, the user is effectively restricted in their use of the protected mobile communication device.

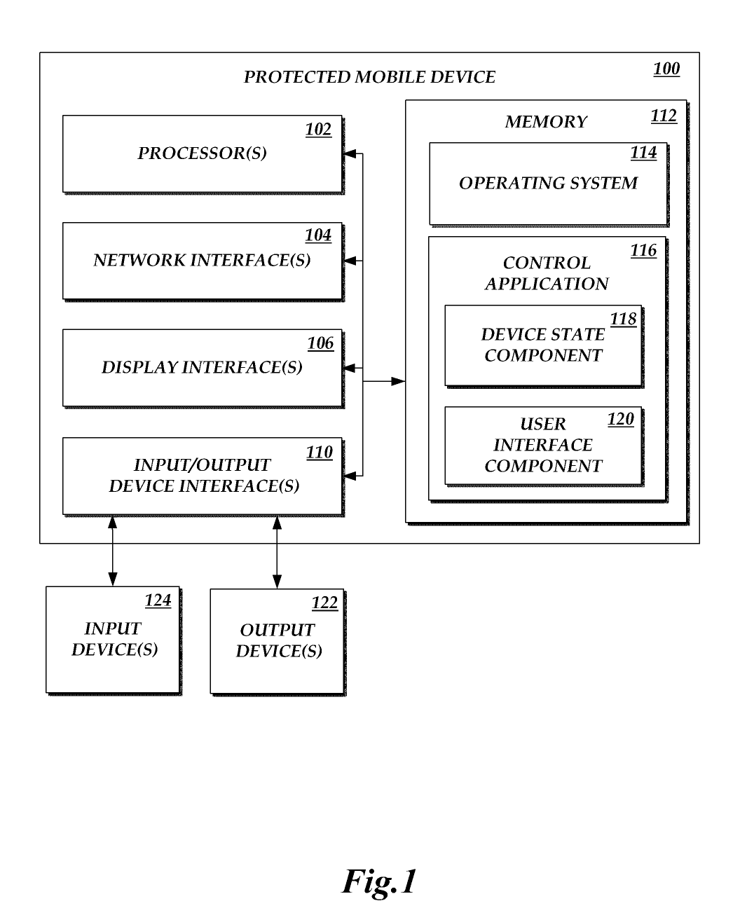

FIG. 1 is a block diagram illustrating an embodiment of a protected mobile communication device 100, including a control application 116 configured to restrict functionality of the device 100 (e.g., under predetermined or hazardous conditions). The protected mobile communication device 100 may have one or more processors 102 in communication with one or more network interfaces 104, display interfaces 106, context sensors 108, and input/output device interfaces 110, all of which communicate with one another by way of a communication bus. The network interfaces 104 may provide connectivity to one or more networks or computing systems. Illustratively, the network interfaces 104 may provide connectivity to a personal area network (PAN), wireless local area network (WLAN), to a wide area network (WAN), to a cellular data or communication network, or any combination thereof. The processor(s) 102 may thus receive information and instructions from other computing systems or services via a network. The processor(s) 102 may also communicate to and from memory 112 and further provide output information or receive input information via the display interfaces 106 and/or the input/output device interfaces 110. The input/output device interfaces 110 may accept input from one or more input devices 124, including, but not limited to, keyboards, touch screens, global positioning system units, vehicle onboard diagnostic sensors (e.g., providing speedometer data), mice, trackballs, trackpads, joysticks, input tablets, trackpoints, remote controls, game controllers, heart rate monitors, velocity sensors, voltage or current sensors, motion detectors, or any other input device capable of obtaining a position or magnitude value from a user. The input/output interfaces may also provide output via one or more output devices 122, including, but not limited to, one or more speakers or any of a variety of digital or analog audio capable output ports, including, but not limited to, headphone jacks, ¼ inch jacks, XLR jacks, stereo jacks, Bluetooth links, RCA jacks, optical ports or USB ports. The display interface 106 may be associated with any number of visual or tactile interfaces incorporating any of a number of active or passive display technologies (e.g., electronic-ink, LCD, LED or OLED, CRT, projection, etc.) or technologies for the display of Braille or other tactile information.

The memory 112 includes computer program instructions that the processor(s) 102 executes in order to implement one or more functionalities of the protected mobile communication device 100. The memory 112 can generally include any combination of RAM, ROM and other persistent or non-transitory computer-readable media. The memory 112 includes an operating system 114 providing the basic functionality of the protected mobile communication device 100, and enabling additional applications to be loaded by the protected mobile communication device 100.

In one embodiment, the operating system 114 restricts functionalities of applications as described with regard to a protected mobile communication device. Illustratively, the operating system 114 may prevent or disallow direct access of applications to radio functionality call stacks, restrict background applications from accessing notifications, and restrict background applications ability to interfere or inhibit executing of other applications. As referred to herein, the operating system 114 may include one or more applications provided in conjunction (“bundled”) with the operating system 114, such as web browsers, mail clients, etc. The operating system 114 enables applications to receive information regarding the protected mobile communication device 100, as well as to interact with functionalities of the protected mobile communication device 100. In one embodiment, the operating system 114 includes an application programming interface (API) for use by applications. Among other functionalities, such an API can enable an application to monitor an activity or functionality state (e.g., as enabled, disabled, locked or unlocked,) of the protected mobile communication device 100, and can enable an application to modify the functionality of the protected mobile communication device 100 (e.g., to disable or enable the protected mobile communication device 100).

The memory 112 further includes a control application 116. The control application 116 is configured to restrict functionality of the protected mobile communication device 100 under a given set of conditions. Illustratively, such a given set of conditions may correspond to detection that the device is traveling at above a threshold speed or within a restricted area. Examples of conditions under which functionality of a mobile communication device should be restricted are described in more detail within U.S. patent application Ser. No. 12/040,832, entitled “MANAGEMENT OF MOBILE DEVICE COMMUNICATION SESSIONS TO REDUCE USER DISTRACTION,” and filed Feb. 29, 2008, which is hereby incorporated by reference in its entirety.

The control application 116 includes a device state component 118. The device state component 118 interacts with the operating system 114 and/or other components of the protected mobile communication device 100 to determine a state of the protected mobile communication device 100. As used herein, the state of the protected mobile communication device 100 includes, without limitation, whether the protected mobile communication device 100 is in an active or inactive state (e.g., whether display interfaces 106 or output devices 122 are currently active), whether the protected mobile communication device 100 is currently locked or unlocked (e.g., whether the operating system 114 is limiting user interaction with the protected mobile communication device 100), whether the protected mobile communication device 100 is otherwise enabled or disabled (e.g., whether specific inputs or outputs of the mobile communication device are disabled or enabled), and whether the control application 116 is currently the primary application operating on the protected mobile communication device 100 (e.g., whether the control application 116 is in the “foreground” or “background” on the protected mobile communication device 100). Functionality to detect each of these states may be provided by the operating system 114. In some embodiments, determination of an active or inactive state may be determined based on detection of a backlight level of an attached display (e.g., where activation of a backlight indicates an active state, and where deactivation of a backlight indicates an inactive state).

In addition, and as will be described in more detail below, the device state component 118 may be configured to restrict the protected mobile communication device 100 to a set of known states when hazardous or predetermined conditions exist. Specifically, after the control application 116 is initially loaded (e.g., by launching of the control application 116 by a user or by automatic launch of the control application 116 at loading of the operating system 114), the device state component 118 may monitor a state of the protected mobile communication device 100. Thereafter, the device state component 118 may respond to any attempt to move the control application 116 into background use by placing the protected mobile communication device 100 into an active and disabled state. The device state component 118 may further ensure that when exiting an active and disabled state, the protected mobile communication device 100 loads the control application 116 as a foreground process. In this manner, the device state component 118 ensures that, when functionality is intended to be restricted, the protected mobile communication device 100 is either 1) inactive, 2) active and in a disabled state, or 3) active and executing an allowed application (e.g., the control application 116) or functionality as the primary running application (e.g., in a foreground state).

The control application 116 further includes a user interface component 120 that is presented while the control application 116 is the primary running application of the protected mobile communication device 100. The user interface component 120 enables a user to interact with the protected mobile communication device 100 in a limited fashion. For example, the user interface component 120 may enable execution of a predetermined set of allowed applications on the protected mobile communication device 120 (e.g., navigational applications) and enable dialing of emergency telephone numbers (e.g., 911 within North America). In some instances, the user interface component 120 may enable override of the control application 116 (e.g., by selection of “passenger mode”). In addition, the user interface component 120 may disallow access to features of the protected mobile communication device 100, such as navigational toolbars or standard user interface inputs. In this manner, the risk of use of the mobile communication device under hazardous conditions may be reduced. Illustratively, the user interface component 120 may disallow access to dialing of non-emergency numbers, text messaging, and mobile gaming applications. Accordingly, while loaded as the primary application on the protected mobile communication device 100, the user interface component 120 can restrict functionality of the device to a limited subset of allowed functions.

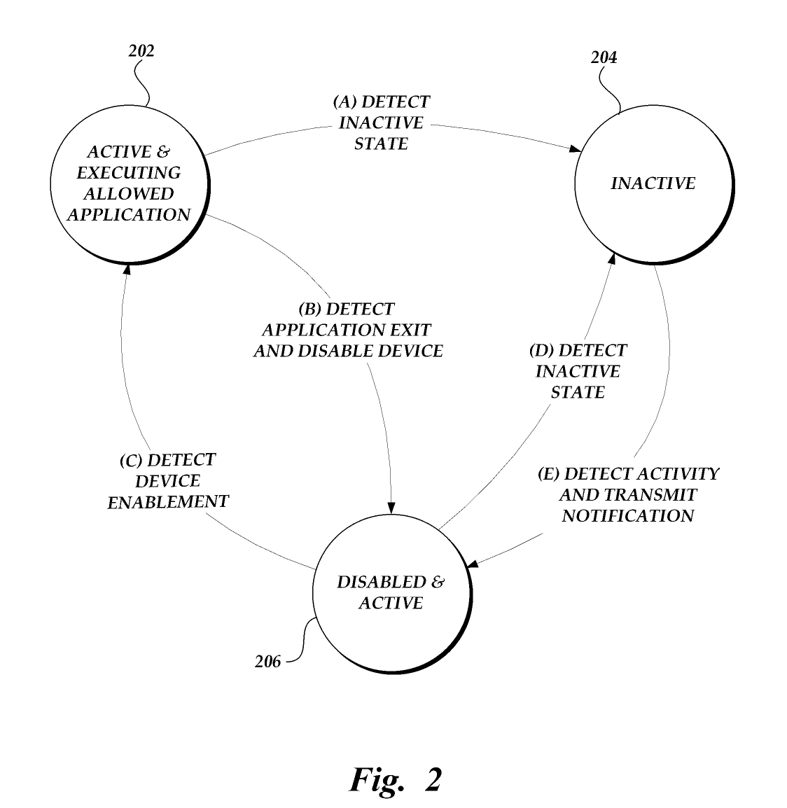

With reference to FIG. 2, an illustrative state diagram depicting states of the protected mobile communication device 100 of FIG. 1 while under control of the control application 116 are displayed. Specifically, FIG. 2 includes representations of three states: an inactive state 204, a disabled (e.g., locked, or unlocked with one or more inputs or outputs functionally restricted) and active state 206, and a state 202 in which an allowed application is executing as a primary application on the mobile communication device 100 (e.g., in the “foreground” of the mobile communication device 100). Various embodiments of the present application may enable any number of allowed applications to execute within state 202. However, for simplicity, the below description will assume that state 202 corresponds to a state in which the mobile communication device is active and executing the control application 116 of FIG. 1. Accordingly, the interactions of FIG. 2 are illustrative of states of the protected mobile communication device 100 while the control application 116 is executing on the protected mobile communication device 100, and while conditions of the protected mobile communication device 100 indicate functionality of the device 100 should be limited.

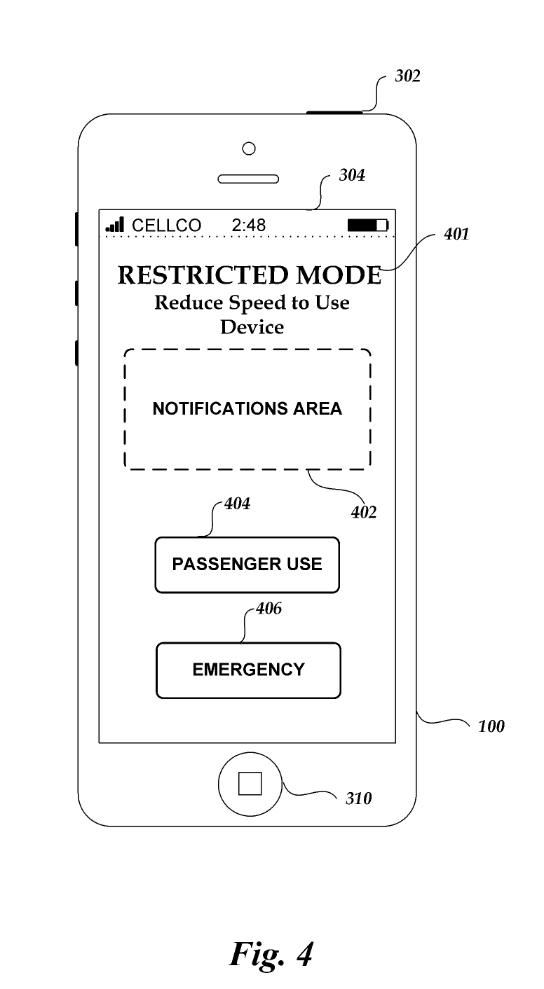

Illustratively, the protected mobile communication device 100 may enter state 202 (corresponding to an active state in which the control application 116 is executing as the primary executing application of the mobile communication device) after a user initiates the control application 116 of FIG. 1 and begins to move at more than a threshold rate of speed (e.g., by driving). Thereafter, the control application 116 presents a user interface that enables only limited functionality of the protected mobile communication device 100. For example, the presented user interface may enable a user to execute a set of allowed applications (e.g., navigational applications) or to dial emergency numbers. The presented user interface may further disallow execution of non-approved application, sending or receiving of text messages or telephone calls, or other non-approved interactions with the protected mobile communication device 100. One example of such a user interface will be discussed below with reference to FIG. 4.

While the protected mobile communication device 100 is in state 202 (e.g., corresponding to a state in which the mobile communication device is active and executing the control application 116), exiting of the state 202 may occur by either rendering the device inactive, or exiting the control application 116. The protected mobile communication device 100 may become inactive either by a lack of interaction with the device 100 for a period of time, or by reception of a predetermined input by a user (e.g., by a user pressing the “power” button of the device 100). In FIG. 2A, rendering of the protected mobile communication device 100 is represented by transition (A). Thereafter, the protected mobile communication device 100 enters the inactive state 204, discussed in more detail below.

Alternatively, exiting of the state 202 (e.g., corresponding to a state in which the mobile communication device is active and executing the control application 116) may occur by exit of the control application 116. Generally described, exit of the control application 116 may include evoking another application as a primarily running application on the protected mobile communication device 100 (e.g., by placing the control application 116 in the “background” of the device). Accordingly, exiting of the control application 116 may occur regardless of whether the control application 116 is still executing on the protected mobile communication device 100 (e.g., in the “background” of the device). In one instance, a user may attempt to exit the control application 116 by interaction with inputs of the protected mobile communication device 100, such as user interface elements, or hardware inputs (e.g., a “home” or “back” button). In another instance, exit of the control application 116 may occur without user input, such as in response to an incoming call or message.

On detecting an exit of the control application 116, the control application interacts with the operating system 114 to place the protected mobile communication device 100 in the active and disabled state 206, as shown in transition (B) of FIG. 2. Illustratively, the control application 116 may place the protected mobile communication device 100 into the active and disabled state 206 by use of an API call to lock the device. For example, on the APPLE IOS™ operating system, a protected mobile communication device 100 may be placed in a locked state by calling the “GSEventLockDevice” or “SBSLockDevice” functions, via APIs, within the IOS™ private framework libraries.

As a further illustration, the control application 116 may place the protected mobile communication device 100 into the active and disabled state 206 by disabling or otherwise hindering one or more inputs or outputs of the protected mobile communication device 100. For example, the control application 116 may interact with an operating system of the protected mobile communication device 100 to cause the dimming of a screen of the mobile communication device 100 to a point where the user is unable to interact with the device. As a further example, the control application 116 may interact with the protected mobile communication device 100 to disable the screen or disable a primary input (e.g., a touch interface) of the device 100, thereby rendering the device disabled for use by a user.

When in the active and disabled state 206, functionality of the protected mobile communication device 100 is limited, either inherently (e.g., by use of a built-in locking mechanism) or, explicitly, by virtue of disabling one or more inputs or outputs of the device 100. Generally, in order to substantively interact with the protected mobile communication device 100, the device 100 must first be re-enabled. In some instances, re-enabling the device 100 may be limited to the use of the built-in locking mechanism of the device. For example, where the device 100 is disabled via a locking function, the device must be unlocked before use. As a further example, where the device 100 is disabled via a reduced functionality of inputs or outputs, re-enabling the device 100 may require first placing the device 100 into the inactive state 204 (e.g., by use of a power button or other functional input), and then returning the device 100 to a disabled and active state 206 corresponding to a locked state (e.g., by use of the power button). Accordingly, exiting of state 206 may require unlocking of the device 100. Unlocking may occur, by way of non-limiting example, by user input of a personal identification number (PIN), by a user executing a predefined input task (e.g., sliding a bar, moving a bubble, etc.), or by user input of biometric information (e.g., a fingerprint).

The control application 116 is configured to ensure that unlocking the mobile communication device 100 returns to the device 100 to the state 202 (e.g., corresponding to a state in which the mobile communication device is active and executing the control application 116) as shown by transition (C). In one embodiment, the protected mobile communication device 100 may be configured to, on successfully unlocking the device 100, enter an application associated with a most recent notification. For example, if the protected mobile communication device 100 has most recently displayed a notification of a text message, unlocking of the mobile communication device 100 may display the text message. Therefore, in order to ensure that unlocking returns to the device 100 to the state 202 (e.g., corresponding to a state in which the mobile communication device is active and executing the control application 116), the control application 116 can verify that it is always (or substantially always) associated with the most recent notification displayed on the protected device 100. Illustratively, on detection of transition (B) of FIG. 2, the control application 116 may cause a notification to appear on the protected mobile communication device 100. Thereafter, the control application 116 can monitor the protected mobile communication device 100 to detect any subsequent notifications (e.g., caused by incoming calls, incoming messages, or other applications), and to immediately respond to such notifications by again displaying its own notification. In one embodiment, the control application 116 may detect the presence of subsequent notifications by other processes based at least in part on activation of a display of the protected mobile communication device 100. For example, the control application 116 may assume that any activation of a display of the protected mobile communication device 100 is the result of an incoming notification by another process, and may respond by display of its own notification. In this manner, unlocking of the protected mobile communication device 100 is ensured to return the device 100 to state 202.

Alternatively, while in the disabled and active state 206, a device may be placed into the inactive state 204 (e.g., either based on lack of use, or user input), as represented by transition (D). The protected mobile communication device 100 can be configured such that any activation of the device 100 causes the device 100 to enter the disabled and active state 206 discussed above, as represented by transition (E). Execution of transition (E) may occur, for example, based on user interaction with the protected mobile communication device 100 (e.g., pressing of a “power” button on the device 100) and/or based on display of a notification by the device 100 (e.g., in response to an incoming call or text message). User interaction with the protected mobile communication device 100 may then proceed as described above.

As will be appreciated by one skilled in the art based on the above description, implementation of the states 202-206 of FIG. 2 therefore allow the user-accessible functionalities of a protected mobile communication device 100 to be limited. Further, the implementation of the states 202-206 does not require that the control application 116 have knowledge of incoming events while the control application 116 is not the primarily executing application on the protected mobile communication device 100, or that the control application 116 be able to directly control all aspects of the device 100. Accordingly, implementation of the states 202-206 is possible even on protected devices, such as those devices implementing the APPLE IOS™ operating system.

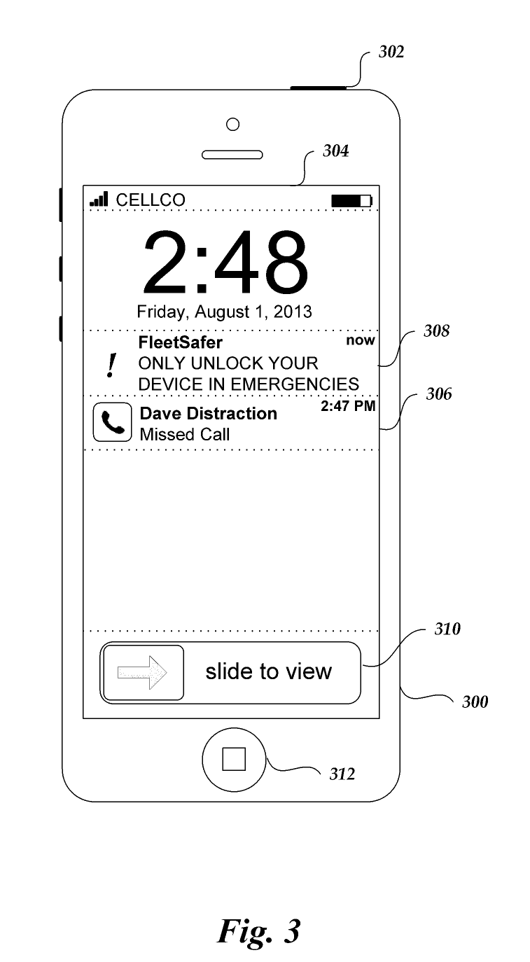

With reference to FIG. 3, an illustrative graphical representation of a mobile communication device, such as a mobile phone 300 (e.g., corresponding to the protected mobile communication device 100 of FIG. 1), executing the control application 116 will be described. Illustratively, the mobile phone 300 is shown in FIG. 3 within a disabled (e.g., locked) and active state. The mobile phone 300 includes a power button 302 operable to toggle the device 100 between an active and inactive state. Illustratively, user selection of the power button 302 while the protected mobile phone 300 is in a disabled and active state may move the phone 300 to an inactive state (e.g., state 204 of FIG. 2). The mobile phone 300 further includes a home button 312 operable to move a currently executing application into a background state, and display a “launcher” application of the phone 100 (e.g., a “home screen”). In the illustrative example of FIG. 3, user selection of the home button 312 is ineffective, as the phone 100 is locked.

In addition, the mobile phone 300 includes a display screen 304 operable to display a “lock screen” user interface, allowing limited functionality of the phone 300 to be accessed by a user. Specifically, the display screen 304 depicts an indication of the current time, battery level, and connection status of the mobile phone 300. In addition, the display screen 304 depicts an unlock input 310 that, when successfully activated by a user, unlocks the mobile communication device 300. The display screen 304 further depicts a list of current notifications, including notifications 306 and 308. In FIG. 3, these notifications are displayed in reverse chronological order. Specifically, notification 306 was initially output or received by the mobile phone 300 at 2:47 PM, while notification 308 was initially output or received at 2:48 PM (the current time on the mobile phone 300). In this illustrative example, notification 306 represents a missed call by a fictional contact of the user of the mobile phone 300, “Dave Distraction.” The mobile phone 300 may be configured, on unlocking, to display an application associated with a most recently displayed notification. Accordingly, were notification 306 the sole notification on the display 304, use of the unlock input 310 may allow a user to access undesirable functionality. In order to prevent such access, the control application 116 is configured to generate notification 308, which is associated with the control application 116. In one embodiment, notification 308 is generated by the control application 116 in response to detection of notification 306. In another embodiment, notification 308 is generated by the control application 116 in response to a specific state of the mobile phone 300 (e.g., detection of activity on the mobile phone 300). Because notification 308 can be consistently regenerated by the control application 116, any attempt to unlock the mobile phone 300 will result in loading of the control application 116. As will be discussed below, user-accessible functionality of the mobile phone 300 is therefore reduced to a limited set of acceptable functionalities.

While one illustrative user interface is shown within FIG. 3, embodiments of the present disclosure may also utilize additional or alternative interfaces. In one embodiment, a protected mobile communication device, such as the mobile phone 300, may enable user selection of individual notifications, such that each notification serves as a selectable input. For example, a user may be enabled by the mobile phone 300 to select notification 306 or 308, and in response to such selection, the mobile phone 300 may launch the application associated with the selected notification. In such embodiments, the control application 116 may be configured to inhibit launching of disallowed applications. Specifically, the control application 116 can detect launching of a disallowed application (e.g., in response to selection of a corresponding notification), and disabled the mobile phone 300 (e.g., by re-locking the mobile phone 300, by dimming a screen of the mobile communication device, or by otherwise disabling an input or output of the mobile phone 300). Accordingly, user selection on the lock screen of a notification corresponding to an unapproved application will merely result in a return to the lock screen.

Conversely, the control application 116 may abstain from locking the screen on selection of a notification corresponding to an allowed application (e.g., a navigational application). Though not shown in FIG. 4, in some embodiments, the control application 116 may place notifications corresponding to each allowed application or functionality onto the lock screen. For example, in some instances the control application 116 may allow restrictions on functionality of the device to be overridden (e.g., in the case of an emergency or operation by a vehicle's passenger). In such instances, the control application 116 may cause generation and display on the display 304 of notifications corresponding to each override option (e.g., a first notification “Passenger Mode,” a second notification “Emergency,” etc.). As described above, the mobile phone 300 may be configured or programmed such that selection of a notification by a user causes execution of a corresponding application. Moreover, the mobile phone 300 may be configured such that an identifier or other indication of the selected notification is transmitted to an associated application. Accordingly, user selection of a “Passenger Mode” notification associated with the control application 116 may return control of the display 304 to the control application 116, which can then invoke a corresponding functionality. Illustratively, the control application 116 may respond to user selection of a “Passenger Mode” notification by causing the mobile phone 300 to immediately enter a “passenger use” mode, without requiring an additional user request to enter the “passenger use” mode. A plurality of notifications may be generated for any allowed or non-restricted functionalities of the mobile phone 300, including functionalities of the control application 116, functionalities of other applications, or functionalities otherwise provided by the mobile phone 300 (e.g., by an operating system). Because a user may directly access such functionalities from a lock screen, use of functionality-specific notifications may reduce or eliminate the need for a dedicated user interface corresponding to the control application 116. While some of the above-described embodiments relate to user-selection of notifications, embodiments of the present application may relate to user-selection of any input element displayed by a lock screen of a mobile device. For example, some mobile devices may be configured to implement widgets, buttons, sliders, or other input elements on one or more lock screens. In such instances, the control application 116 may be configured to detect the use of such inputs to access restricted functionalities of the mobile device, and to return the device to a lock state. Moreover, the control application 116 may be configured to generate and display to the user one or more inputs (e.g., widgets, sliders, buttons, etc.) associated with allowed functionalities, thereby enabling a user to directly access such allowed functionalities from the lock screen.

With respect to FIG. 4, an illustrative graphical representation of the mobile phone 300 while unlocked and primarily executing the control application 116 will be described. Specifically, in FIG. 4, the display 304 corresponds to a user interface at least partially generated by the control application 116. The user interface includes a restriction notification 401, which reflects that functionality of the phone 300 is currently limited (e.g., due to excessive speed). The interface further includes a notification area 402, which may output a limited amount of information to a user (e.g., a notice of received or blocked calls, messages, etc.). The passenger override input 404 is selectable by a user to indicate to the control application 116 that the phone 300 is being utilized by a passenger. Illustratively, selection of input 404 may result in functional restrictions being disabled or removed from the device (e.g., the control application 116 may allow a user to execute previously restricted applications or functionalities). The display 304 further depicts an emergency input 406 that, when selected by a user, places a call to an emergency contact number (e.g., “911”).

While not explicitly depicted, it is contemplated that the user interface of FIG. 4 does not enable a user to access restricted functionalities of the phone 300. For example, the interface may remove elements typically provided by the phone 300 in order to prevent the user from accessing restricted functionalities. Further, the control application 116 may take action to prevent instantiating an unapproved application as the primary executing application. For example, if a user selects home button 310 (which, in this example, is a hardware button whose functionality cannot be directly modified by the control application 116), the control application 116 is configured to lock the mobile phone 300. Accordingly, the phone 300 may be returned to the state depicted in FIG. 3, where functionality continues to be limited. Therefore, a user may be prevented from accessing restricted functionality by the control application 116, even when some elements of the phone 300 (e.g., the home button 310) cannot be directly modified by the control application 116.

While embodiments above describe the use of local functionality of a device to place a device into a locked state, embodiments of the present disclosure may additionally or alternative utilize external locking functionality. Illustratively, a Bluetooth or USB protocol keyboard may support a screen lock function. Accordingly, logic may be included within the keyboard to send a key lock code over a BLUETOOTH™ or USB interface to lock the device. As a further illustration, mobile phone carriers or services may use specially formatted short message service (SMS) or unstructured supplementary service data (USSD) messages to limit device functionality or place a device in a locked state (e.g., inform prepaid and roaming subscribers that their credit balance is now zero and service has been terminated.) Embodiments of the present disclosure may utilize such SMS or USSD message to place the device into a locked state.

In an aspect of the present disclosure, a policy manager can utilize policy information regarding usage of a mobile communication device and then request an external system to apply the lock to the mobile communication device. Use of external locking mechanisms may be preferable, for example, where the ability of software to utilize local locking functionality is limited. Illustratively, an operating system of a mobile communication device may not allow locally executing software to lock a device, but may enable external devices, such as keyboard or headset, to do so.

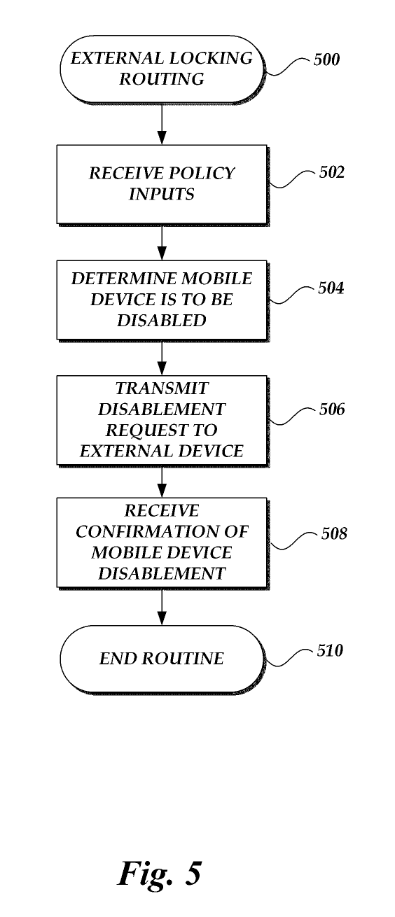

One illustrative routine 500 to utilize an external locking mechanism to enforce a restrictions policy on a mobile communication device will be described with respect to FIG. 5. The routine 500 may be implemented on a mobile communication device being managed, on an external policy manager (e.g., an external computing device, keyboard, headset, audio player, etc.), or any combination thereof. In one embodiment, the routine 500 may be implemented at least in part by software executing on a local device. Specifically, such software may determine that the device should be placed into a locked state, and request that an external device (e.g., a BLUETOOTH™ headset) transmit a lock signal to the device. In another embodiment, the routine 500 may be implemented at least in part by an external device. Specifically, such an external device may function to determine that the mobile communication device should be placed into a locked state, and transmit a lock signal to the mobile communication device independent of instructions by the mobile communication device. For example, a vehicle's navigation system (audio player, etc.) may determine that a threshold speed has been reached, and transmit a lock signal to a mobile communication device via an existing communication channel (e.g., a BLUETOOTH™ or USB interface). In yet another embodiment, multiple mobile communication devices (either including or excluding the managed mobile communication device) may operate in conjunction to implement the routine 500. Accordingly, a variety of inputs can be utilized by the multiple devices to determine that a managed mobile communication device should be placed into a locked state. Illustratively, one or more external devices (e.g., a headset, a keyboard, a vehicle, or an on-board-diagnostics system or interface) may independently determine that a mobile communication device should be placed into a locked state. A quorum protocol or other consensus protocol could then be used to determine whether to lock a device. The quorum protocol may be implemented on the mobile communication device itself (which, in some instances may also make a determination as to whether a lock state should be implemented), on an external device, or on a combination of devices. Advantageously, use of an existing external device, such as a headset or vehicle, to implement lock policy may reduce or eliminate the need to securely “pair” the device to the mobile phone.

The routine 500 begins at block 502, where inputs utilized to implement a restrictions policy are received at a device implementing the routine 500. For ease of description, the device implementing the routine 500 will be referred to hereafter as the “policy manager.” In various embodiments, the policy manager can use several inputs to make policy decisions regarding mobile communication device usage. For example an administrator may establish rules about how a device may be used, when it may be used and for what purpose. The policy manager can then gather additional information regarding the way a device is being used. This may include the types of applications running, the context of the device (i.e. is the device moving in a manner consistent with a vehicle, or is the device in a restricted geographic zone), the current time and whether the device is currently locked.

Thereafter, at block 504, the policy manager can determine whether the received inputs, when processed according to an established policy or set of policy rules, require that the mobile communication device be disabled. When the policy requires that the device be disabled, the policy manager may further determine that the device is not currently disabled. In such an instance, at block 506, the policy manager can transmit a request to an external (e.g., an external BLUETOOTH™ device) device to disable the mobile communication device. In one embodiment, the external device may disable the mobile communication device by use of an external locking functionality. In other embodiments, the external device may disable the mobile communication device by otherwise reducing functionality of the mobile communication device (e.g., by reducing a screen brightness of the mobile communication device, by displaying a blank screen on the mobile communication device, or by disabling inputs of the mobile communication device).

Thereafter, at block 508, the policy manager can receive a confirmation that the mobile communication device has been disabled. In some embodiments, either or both of the mobile communication device or the external device can issue a notification as to successful disablement to the policy manager. In other embodiments, the policy manager may verify that the mobile communication device is disabled based on querying the mobile communication device. In some instances, where the policy manager receives no lock notification within a timely manner, the policy manager can retransmit the disablement request. Thereafter, the routine 500 ends at block 510.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The steps of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor such that the processor can read information from, and write information to, the storage medium. In the alternative, the storage medium can be integral to the processor device. The processor device and the storage medium can reside in an ASIC. The ASIC can reside in a user terminal. In the alternative, the processor and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A computer-implemented method of restricting functionality on a protected mobile communication device, the method comprising:
detecting set of conditions under which functionality of the protected mobile communication device is to be restricted;
displaying a restricted interface on the protected mobile communication device, wherein the restricted interface at least partially limits functionality of the protected mobile communication device that is accessible to a user;
detecting that the restricted interface is no longer a primary interface of the protected mobile communication device; and
in response to detecting that the restricted interface is no longer a primary interface of the protected mobile communication device:
locking the protected mobile communication device; and
generating a notification on the protected mobile communication device associated with the restricted interface, wherein the protected mobile communication device is configured to, on unlocking by the user, display an interface associated with a most recently generated notification.

2. The computer-implemented method of claim 1, wherein the protected mobile communication device utilizes an APPLE IOS™ operating system.

3. The computer-implemented method of claim 1, wherein the method is implementing by an application executing on the protected mobile communication device.

4. The computer-implemented method of claim 3, wherein the protected mobile communication device does not enable the application to directly control a response to incoming telephone calls.

5. The computer-implemented method of claim 3, wherein the protected mobile communication device restricts the application from interfering with a user request to display a standard user interface of the protected mobile communication device.

6. The computer-implemented method of claim 3, wherein the protected mobile communication device does not notify the application of at least one of incoming telephone calls or incoming notifications.

7. The computer-implemented method of claim 1 further comprising:
detecting that the protected mobile communication device has exited an inactive state; and
in response to detecting that the protected mobile communication device has exited an idle state, generating a second notification with the restricted interface on the protected mobile communication device.

8. A mobile computing device including conditional-specific functionality restrictions, the mobile computing device comprising:
a data store including information specifying criteria for restricting functionality of the mobile computing device; and
a processor in communication with the data store, the processor configured with specific computer-executable instructions to:
determine that the criteria for restricting functionality of the mobile computing device is satisfied;
display a restricted interface on the mobile computing device at least partially limiting functionality of the mobile computing device that is accessible to a user;
detect that the restricted interface is no longer a primary of the mobile computing device; and
in response to detection that the restricted interface is no longer a primary of the mobile computing device:
execute a responsive action, wherein the responsive action comprises at least one of locking the mobile computing device or dimming a screen of the mobile computing device; and
generate a notification on the mobile computing device, wherein the mobile computing device is configured, on unlocking by the user, to display an interface associated with a most recently generated notification.

9. The mobile computing device of claim 8, wherein the specific computer-executable instructions further configure the processor to:
detect generation, on the mobile computing device, of a notification not associated with the restricted interface; and
in response to the notification not associated with the restricted interface, generate a second notification associated with the restricted interface on the protected mobile communication device.

10. The mobile computing device of claim 9, wherein the notification not associated with the restricted interface is detected based at least in part on a state of a screen of the mobile computing device.

11. The mobile computing device of claim 9, wherein the specific computer-executable instructions further configure the processor to:
detect selection, by a user, of the notification not associated with the restricted interface;
in response to selection of the notification not associated with the restricted interface, lock the protected mobile communication device.

12. The mobile computing device of claim 9, wherein the specific computer-executable instructions further configure the processor to determine that the notification not associated with the restricted interface is associated with a disallowed interface.

13. The mobile computing device of claim 8, wherein the generated notification is associated with an allowed interface.

14. The mobile computing device of claim 13, wherein the specific computer-executable instructions further configure the processor to generate at least one additional notification associated with an additional allowed interface.

15. A non-transitory computer-readable storage medium comprising computer-executable instructions to implement functionality restrictions on a mobile computing device, wherein the computer-executable instructions, when executed by the mobile computing device, configure the mobile computing device to:
display a restricted interface on the mobile computing device at least partially limiting functionality of the mobile computing device that is accessible to a user;
detect that the restricted interface is no longer a primary of the mobile computing device; and
in response to detection that the restricted interface is no longer a primary of the mobile computing device:
execute a responsive action, wherein the responsive action comprises at least one of locking the mobile computing device or disabling an output of the mobile computing device; and
generate a notification on the mobile computing device, wherein the mobile computing device is configured, on unlocking by the user, to display an interface associated with a most recently generated notification.

16. The non-transitory computer-readable storage medium of claim 15, wherein locking the mobile computing device causes display of a lock screen interface at least partly restricting an ability of the user to interact with the mobile computing device prior to unlocking.

17. The non-transitory computer-readable storage medium of claim 15, wherein locking the mobile computing device comprises transmitting a request to lock the mobile computing device to at least one external device in communication with the mobile computing device.

18. The non-transitory computer-readable storage medium of claim 16, wherein locking the mobile computing device further comprises receiving a confirmation that the mobile computing device has been locked.

19. The non-transitory computer-readable storage medium of claim 17, wherein the confirmation is received from at least one of the external device or the mobile computing device.

20. The non-transitory computer-readable storage medium of claim 16, wherein the external device comprises at least one of a keyboard, a headset, a vehicle navigation system, or a vehicle diagnostic system.

21. The non-transitory computer-readable storage medium of claim 16, wherein the external device communicates with the mobile computing device via at least one of BLUETOOTH™, short messaging service (SMS), or unstructured supplementary service data (USSD).
